(19) United States
(12) Patent Application Publication
(10) Pub. No.: US 2026/0259092 A1
(43) Pub. Date: Sep. 3, 2026

(54) SENSOR

(71) Applicant: Junji SONE, Chigasaki-shi, Kanagawa (JP)

(72) Inventors: Junji SONE, Chigasaki-shi, Kanagawa (JP); Liwei LIN, Berkeley, CA (US); Tatsuya SATO, Yokohama-shi, Kanagawa (JP); Shimmyo YANAGAWA, Minato-ku, Tokyo (JP)

(21) Appl. No.: 18/873,014

(22) PCT Filed: Jun. 13, 2022
(86) PCT No.: PCT/JP2022/023613

§ 371 Date: Dec. 9, 2024

(51) Int. Cl. G01L 5/00; G01L 1/16

(52) U.S. Cl. CPC G01L 5/0028; G01L 1/16

(57) ABSTRACT

A sensor includes: a first film and a second film that generate a voltage when subjected to a force, a pressure, or a vibration; a plurality of film-like first electrodes provided on one of the surfaces of the first film so as to be set away from each other by prescribed intervals; a film-like second electrode provided on one of the surfaces of the second film; and a dielectric member formed from rubber having dielectric properties into the shape of a thin plate having holes formed therein, the other surface of the first film being affixed to a first surface that is a prescribed surface of the dielectric member, and the other surface of the second film being affixed to a second surface, opposite the first surface, of the dielectric member.

### TECHNICAL FIELD

The present invention relates to a sensor, specifically a sensor that converts applied force, pressure, or vibration into voltage.

### BACKGROUND TECHNOLOGY

Tactile feedback and haptic feedback are important for surgical systems and teleoperation tasks. To provide tactile and force feedback, it is necessary to detect applied force, pressure, or vibration.

Someya et al. worked on developing a system that can measure biological information without interfering with the movement of living tissue by attaching it to human tissue or body surfaces. By forming an organic device on an ultra-thin polymer film approximately 1 micrometer thick, they successfully created a remarkably durable flexible organic device, despite its ultra-thin profile. The world's lightest and thinnest soft organic transistor integrated circuit they created maintains its electrical performance and does not break mechanically, even when the film is bent down to a curvature radius of 5 micrometers. Using this organic transistor integrated circuit, Someya et al. successfully prototyped a soft touch sensor system.

Furthermore, similar sensors are also being researched at Stanford University (see, for example, Non-Patent Document 1).

### PRIOR ART DOCUMENTS

### Patent Literature

Non Patent Literature 1: Weichen Wang, . . . Zhenan Bao, Strain-insensitive intrinsically stretchable transistors and circuits, Nature Electronics volume 4, pages 143-150 (2021)

### SUMMARY OF THE INVENTION

### The Problem to be Solved by the Invention

However, when making the sensor thinner and more flexible, it becomes challenging to maintain sensitivity for detecting force, pressure, or vibration.

This invention was developed in view of such circumstances, aiming to achieve a thinner, more flexible sensor capable of detecting force, pressure, or vibration with higher sensitivity.

### The Means for Solving the Problem

A sensor according to one aspect of the present invention includes a first film that generates voltage when force, pressure, or vibration is applied, multiple first electrodes arranged on one side of the first film with a predetermined spacing, a second film that also generates voltage when force, pressure, or vibration is applied, and a second electrode on one side of the second film. Additionally, it includes a dielectric member formed of a thin, rubber-like material with holes, providing dielectric properties. The other side of the first film is attached to a first surface of the dielectric member, while the other side of the second film is attached to the second surface opposite the first. A charge-accumulating agent is placed within the holes to assist in charge storage, and voltage is generated between any or all of the first electrodes and the second electrode in response to applied force, pressure, or vibration, either in part or in whole.

The spacing between the multiple first electrodes on one side of the first film can be set below the two-point discrimination threshold of human skin.

A predetermined voltage can be applied to the dielectric member to precharge the electric charge.

A hole formed in the dielectric member may extend from the first surface to the second surface.

Any of the multiple first electrodes and the second electrode can be arranged between the first film and the second film to sandwich the portion of the dielectric member in which the hole is formed.

The cross-sectional shape of the hole formed in the dielectric member on the first surface can be made similar to the shape of the surface of the film-like first electrode.

The first electrode can be disposed across the first film on a cross section of the hole formed in the dielectric member, the cross section being on the first surface.

Any of the multiple first electrodes and the second electrode can be arranged between the first film and the second film to sandwich a portion of the dielectric member that is separate from the portion in which the hole is formed.

A pressing means may further be provided for pinching and pressing the ends of the first film, the second film and the dielectric member.

A plurality of second electrodes may be provided, and each of the second electrodes may be provided at a position facing each of the first electrodes.

When detecting the shape or pattern of the surface of an object or the force of contact with the object, a pressing means can be further provided for displacing the first film, the first electrode, the second film, the second electrode and the dielectric member to press them against the skin.

The pressing means can use gas or liquid pressure to displace the first film, the first electrode, the second film, the second electrode and the dielectric member and press them against the skin.

The pressing means can be configured to cause the first film, the first electrode, the second film, the second electrode and the dielectric member to be displaced by a cam and pressed against the skin.

The pressing means can be pulled by a wire through a pulley to displace the first film, the first electrode, the second film, the second electrode and the dielectric member so as to be pressed against the skin.

### EFFECT OF INVENTION

As described above, according to the present invention, it is possible to make the sensor thinner and more flexible and to detect force, pressure or vibration with higher sensitivity.

### BRIEF DESCRIPTION OF THE DRAWINGS

FIG. 1 is a block diagram of a tactile sensing system 11 including a tactile sensing pad, which is an example of a sensor.

FIG. 2 is a diagram showing an example of the configuration of a tactile sensing pad group 21.

FIG. 3 is a diagram illustrating another example of the configuration of the tactile sensing pad group 21.

FIG. 4 is a diagram illustrating still another example of the configuration of the tactile sensing pad group 21.

FIG. 5 is a plan view illustrating an example of a configuration of the tactile sensing pad 73.

FIG. 6 is a cross-sectional view showing a cross section of the tactile sensing pad 73 in the AA″ line in FIG. 5.

FIG. 7 is a cross-sectional view showing a cross section of the tactile sensing pad 251.

FIG. 8 is a cross-sectional view showing a cross section of the tactile sensing pad 301.

FIG. 9 is a cross-sectional view showing a cross section of the tactile sensing pad 351.

FIG. 10 is a cross-sectional view showing a cross section of the tactile sensing pad 401.

FIG. 11 is a diagram illustrating a state of the tactile sensing pad 73 attached to the finger abdomen.

### EMBODIMENTS FOR IMPLEMENTING THE INVENTION

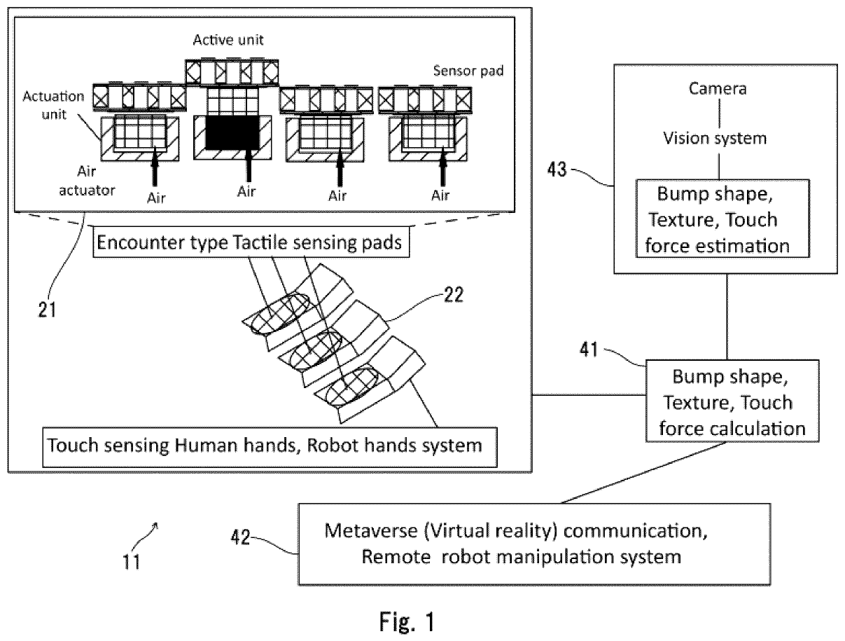

A sensor according to an embodiment of the present invention will be described below with reference to FIGS. 1 to 11.

FIG. 1 is a block diagram of a haptic sensing system 11 including a haptic sensing pad, which is an example of a sensor. The haptic sensing system 11 converts force, pressure, or vibration that causes a human being haptic or pressure sense to be converted into information. For example, the tactile sensing system 11 detects the unevenness or pattern of an object when it is touched by a human finger or palm or a robotic hand, and the force with which the object is touched. The object to be touched by a human finger or palm or a robotic hand may be anything that has substance, such as a human being or an object.

The tactile sensing system 11 includes a group of tactile sensing pads 21, a robot system 22, a tactile/pressure drive information calculation system 41, a virtual reality computer system/remote robot manipulation system 42 and an image processing system 43.

The tactile sensing pad group 21 includes a plurality of tactile generation pads and actuators that press certain tactile generation pads against the skin. The tactile sensing pads 21 detect force, pressure or vibration. It can also be said that the tactile sensing pad group 21 detects the subject's sense of touch.

The tactile sensing pad group 21 is created using MEMS (Micro Electro Mechanical Systems), ultra-precision cutting, 3D printing technology (three-dimensional modeling technology), and precision bonding technology. The tactile sensing pad group 21 is attached to the body, such as on the fingers, palms, backs of the hands, wrists, elbows, shoulders, chest, back or waist, by means of a fixing band, harness, gloves or clothing. For example, the shape of the tactile sensing pad group 21 is a surface shape corresponding to the palmar surface of the distal phalanx of the second finger (index finger), and has a thickness of 0.2 mm or more and less than 0.5 mm. For example, the shape of the tactile sensing pad group 21 is a surface shape corresponding to the palm side of the right hand, and has a thickness of 0.2 mm or more and less than 0.5 mm. For example, if the tactile sensing pad group 21 is attached to the palm of the hand, when a person touches an object such as a human or an object with the palm of the hand, the tactile sensing pad group 21 detects the force, pressure, or vibration generated when pressed against the object such as a human or an object. The tactile sensing pad group 21 outputs the detected force, pressure or vibration as a voltage.

It can also be said that the tactile sensing pad group 21 detects force, pressure or vibration that produces a tactile, pressure or vibration sensation, and outputs the detected force, pressure or vibration as a voltage. In other words, the tactile sensing pads 21 detect the subject's touch, pressure or vibration sensation.

The robot system 22 is equipped with a robot hand and performs operations such as touching, grasping, and carrying objects such as humans and objects. A group of tactile sensing pads 21 are attached to the robot hand of the robot system 22. The tactile sensing pads 21 detect force, pressure or vibration. That is, when the robot hand of the robot system 22 touches or grasps an object such as a human or an object, the tactile sensation of the object is detected as force, pressure, or vibration. For example, the tactile sensing pad group 21 and the robot system 22 trace the surface of an object and detect tactile sensations according to the shape of the object, such as bumps and patterns. The tactile/pressure drive information calculation system 41 acquires a force, pressure or vibration signal that is detected by the tactile sensing pad group 21 and indicates the sensation of the target.

Hereinafter, an object that is touched by the tactile sensing pad group 21 and detects force, pressure or vibration, and that is a person or an object, will be referred to as a contact object.

The image processing system 43 includes an imaging device and an image processing device, and estimates the unevenness and pattern of a target such as a human or object, and the force exerted when contacted, from an image captured of the target, and supplies information indicating the unevenness and pattern of the target, and the force exerted when contacted, to the tactile/pressure drive information calculation system 41.

The tactile/pressure drive information calculation system 41 is composed of an analog signal processing device and a computer system, and converts the force, pressure or vibration data indicating the feel of the contact object detected by the tactile sensing pad group 21 into information that can be handled by a computer. For example, the tactile/pressure drive information calculation system 41 applies signal processing such as noise removal and dynamic range conversion to the force, pressure or vibration signals indicating the sensation of the contact object obtained from the tactile sensing pad group 21, and performs analog/digital conversion. Furthermore, for example, the tactile/pressure drive information calculation system 41 converts the force, pressure or vibration data, which is digital data, into data in a predetermined format. For example, the tactile/pressure drive information calculation system 41 converts force, pressure or vibration data into data in a format arranged so that values indicating force or pressure indicate spatial or temporal positions.

In addition, the tactile/pressure drive information calculation system 41 converts information indicating the unevenness or pattern of the object estimated by the image processing system 43, and the force exerted when contacted, into force, pressure or vibration data in a specified format.

Furthermore, for example, the tactile/pressure drive information calculation system 41 may link the unevenness or pattern of the object, and the force applied when contacted, estimated by the image processing system 43, with the force, pressure or vibration data indicating the feel of the contacted object detected by the tactile sensing pad group 21.

The Tactile/pressure drive information calculation system 41 provides force, pressure or vibration data in a predetermined format to a virtual reality computer system/remote robotic manipulation system 42.

The virtual reality computer system/remote robot manipulation system 42 uses force, pressure or vibration data in a specified format for control purposes such as communication in the metaverse (virtual reality) and presenting touch and pressure sensations in tasks using remote robots. For example, the virtual reality computer system/remote robotic manipulation system 42 calculates contacts, abutments or collisions of the avatar with other avatars or objects in the virtual space in response to the avatar's movements in the virtual space. For example, the virtual reality computer system/remote robotic manipulation system 42 calculates tactile information, such as touch, pressure or vibration sensations, of other avatars or objects when the avatar contacts or collides with other avatars or objects in the virtual space.

Hereinafter, the tactile sensing pad group 21 will now be described.

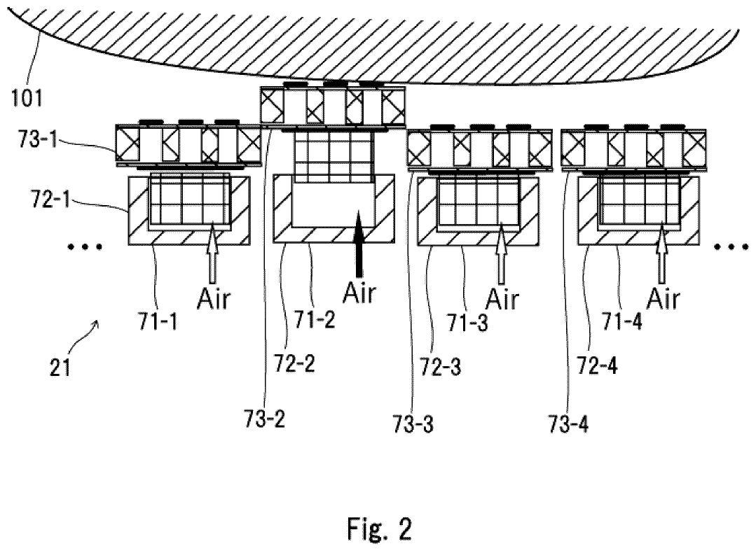

FIG. 2 is a diagram showing an example of the configuration of the tactile sensing pad group 21.

The tactile sensing pad group 21 is configured to include approximately three to ten tactile sensing pads 73.

Each of the tactile sensing pads 73 has between 10 and 50 detection points. The detection points on the tactile sensing pad 73 are arranged in the left-right direction and the front-back direction (depth direction) in FIG. That is, the detection points are arranged two-dimensionally at predetermined intervals on the surface of the touch sensing pad 73 that comes into contact with the touch object.

In the following description, a portion of the detection points of the tactile sensing pad 73 will be described as an example. When a predetermined tactile sensing pad 73 among the multiple tactile sensing pads 73 arranged in a row contacts a contact object to detect force, pressure or vibration, the tactile sensing pad group 21 moves the predetermined tactile sensing pad 73 in the direction of the contact object so as to contact a predetermined part of the contact object.

Hereinafter, for example, when the tactile sensing pad group 21 includes four tactile sensing pads 73, the tactile sensing pads 73 will be referred to as tactile sensing pads 73-1 to 73-4, etc., when they are to be distinguished from one another.

FIG. 2 shows an example of the configuration of the tactile sensing pad group 21 including four tactile sensing pads 73-1 to 73-4. Tactile sensing units 71-1 to 71-4 are configured to include air actuators 72-1 to 72-4, respectively, and tactile sensing pads 73-1 to 73-4, respectively. Each of the tactile sensing units 71-1 to 71-4 operates individually and independently to detect force, pressure, or vibration.

The tactile sensing pad 73-1 has a plurality of electrodes formed on the surface thereof that comes into contact with the touch target 101, as will be described in detail later. Similarly, each of the tactile sensing pads 73-2 to 73-4 has a plurality of electrodes formed on the surface that comes into contact with the touch target 101, as will be described in detail later.

In each of the tactile sensing pads 73-1 to 73-4, a plurality of electrodes formed on the surface that comes into contact with the touch target 101 are detection points that detect force, pressure, or vibration.

The intervals between the multiple electrodes formed on each of the tactile sensing pads 73-1 to 73-4 are set to be less than the two-point discrimination threshold of human skin. That is, the distance between the electrodes is less than the two-point discrimination threshold of human skin. For example, the two-point discrimination threshold of human skin is said to be 1 to 6 mm on the fingertips and 15 to 20 mm on the palms or soles. For example, the two-point discrimination threshold of human skin is said to be 2 to 3 mm on the lips and 30 mm on the back of the hand or foot.

In this way, forces, pressures or vibrations at intervals below the two-point discrimination threshold of human skin can be detected. By using the information (signals) obtained from the tactile sensing pad group 21 in a device that applies stimuli that induce tactile, pressure or vibration sensations at intervals less than the two-point discrimination threshold of human skin, it is possible to reproduce the tactile, pressure or vibration sensations applied to human skin.

In addition, the two-point discrimination threshold of human skin is 2 to 3 mm on the lips, which is the shortest on the body, so by making the distance between the electrodes less than 2 mm, the information obtained by tactile sensing pads 73-1 to 73-4 can be used on any part of the body.

The tactile sensing pads 73-1 to 73-4 are moved by the air actuators 72-1 to 72-4, respectively, toward the contact target 101 so as to come into contact with predetermined portions of the contact target 101. Each of the air actuators 72-1 to 72-4 is a pneumatic actuator consisting of a cylinder and a piston. When compressed air of a predetermined pressure is supplied to each of the air actuators 72-1 to 72-4, the piston protrudes into the cylinder, displacing one of the tactile sensing pads 73-1 to 73-4 fixed to the piston, thereby moving it toward the contact object 101. For example, at a specified time, air actuator 72-2 is supplied with compressed air of a specified pressure, which displaces tactile sensing pad 73-2, thereby moving it toward contact object 101, whereas air actuators 72-1, 72-3, and 72-4 are not supplied with compressed air of a specified pressure, and therefore do not move tactile sensing pads 73-1, 73-3, and 73-4 toward contact object 101. At this time, the tactile sensing pad 73-2 detects force, pressure or vibration. That is, at this time, the tactile sensing pad 73-2 detects the unevenness or pattern of the contact object 101, or the force, pressure, or vibration applied to the contact object 101.

At a predetermined time, all of tactile sensing pads 73-1 to 73-4 or any one or more of tactile sensing pads 73-1 to 73-4 are moved by air actuators 72-1 to 72-4, respectively, toward contact object 101 so as to contact a predetermined portion of contact object 101, or all of tactile sensing pads 73-1 to 73-4 are moved away from contact object 101.

Hereinafter, when there is no need to distinguish between the tactile sensing units 71-1 to 71-4, they will simply be referred to as tactile sensing unit 71. Hereinafter, when there is no need to distinguish between the air actuators 72-1 to 72-4, they will simply be referred to as air actuator 72.

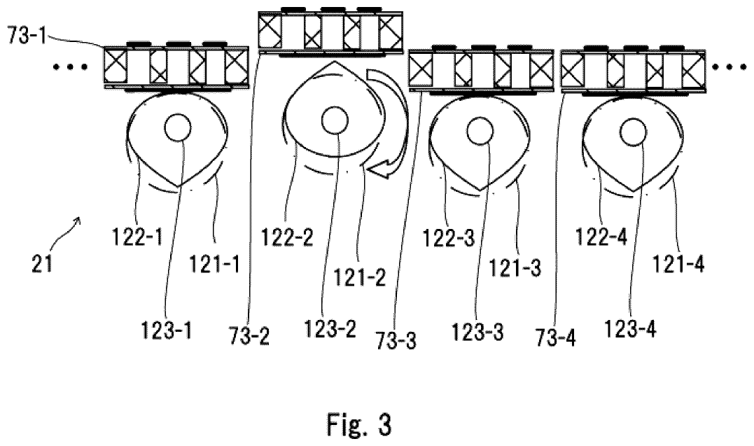

FIG. 3 is a diagram showing another example of the configuration of the tactile sensing pad group 21 including four tactile sensing pads 73-1 to 73-4. Tactile sensing units 121-1 to 121-4 are configured to include tactile sensing pads 73-1 to 73-4, cams 122-1 to 122-4, and motors 123-1 to 123-4, respectively. Tactile sensing units 121-1 to 121-4 each operate individually and independently to detect force, pressure, or vibration.

The tactile sensing pads 73-1 to 73-4 in FIG. 3 are moved toward the contact target 101 by the cams 122-1 to 122-4 and the motors 123-1 to 123-4, respectively, so as to come into contact with predetermined portions of the contact target 101. For example, each of the cams 122-1 to 122-4 is a rotary plate cam. For example, each of the cams 122-1 to 122-4 is made of an eccentric disk. For example, each of the motors 123-1 to 123-4 is an electric motor. That is, the cams 122-1 to 122-4 are rotated by the motors 123-1 to 123-4, respectively, and when they reach a predetermined angular position with respect to the tactile sensing pads 73-1 to 73-4, respectively, they push the tactile sensing pads 73-1 to 73-4 toward the contact target 101, respectively.

For example, at a specified time, cam 122-2 is rotated by motor 123-2, and when the side of cam 122-2 protruding from the rotation axis moves toward tactile sensing pad 73-2, tactile sensing pad 73-2 is pushed out and displaced, thereby moving it toward contact object 101, and cams 122-1, cam 122-3, and cam 122-4 do not move tactile sensing pad 73-1, tactile sensing pad 73-3, and tactile sensing pad 73-4 toward contact object 101, because motors 123-1, 123-3, and 123-4, respectively, do not rotate. At this time, the tactile sensing pad 73-2 detects force, pressure or vibration. That is, at this time, the tactile sensing pad 73-2 detects the unevenness or pattern of the contact object 101, or the force, pressure, or vibration applied to the contact object 101.

At a predetermined time, all of tactile sensing pads 73-1 to 73-4 or any one or more of tactile sensing pads 73-1 to 73-4 are moved by cams 122-1 to 122-4, respectively, toward contact object 101 so as to contact a predetermined portion of contact object 101, or all of tactile sensing pads 73-1 to 73-4 are moved away from contact object 101.

For example, the tactile sensing pads 73-1 to 73-4 are biased away from the contact target 101 by a spring or the like (not illustrated).

Although each of the cams 122-1 to 122-4 has been described as a plate cam, the present invention is not limited to this and may be a groove cam or a solid cam. Further, although the motors 123-1 to 123-4 have been described as being electric motors, the present invention is not limited to this and may be a pressure motor that utilizes the pressure of a fluid, a molecular motor, or an ultrasonic motor.

Hereinafter, when there is no need to distinguish between the tactile sensing units 121-1 to 121-4, they will simply be referred to as tactile sensing units 121. Hereinafter, when it is not necessary to distinguish between the cams 122-1 to 122-4, they will be simply referred to as cams 122. Moreover, when there is no need to distinguish between the motors 123-1 to 123-4, they will be simply referred to as motors 123.

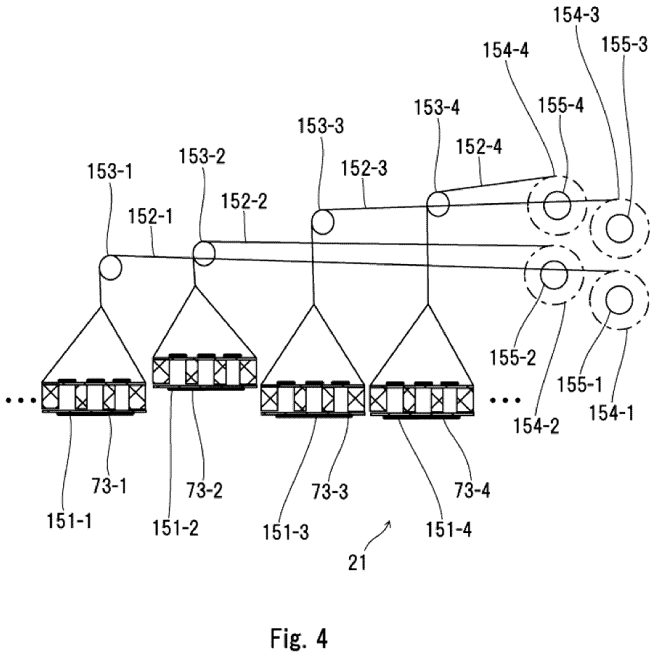

FIG. 4 is a diagram showing yet another example of the configuration of the tactile sensing pad group 21 including four tactile sensing pads 73-1 to 73-4. Tactile sensing units 151-1 to 151-4 are configured to include tactile sensing pads 73-1 to 73-4, wires 152-1 to 152-4, pulleys 153-1 to 153-4, pulleys 154-1 to 154-4, and motors 155-1 to 155-4, respectively.

Tactile sensing units 151-1 to 151-4 each operate individually and independently to detect force, pressure, or vibration.

Tactile sensing pads 73-1 to 73-4 in FIG. 4 are moved toward contact object 101 by wires 152-1 to 152-4, pulleys 153-1 to 153-4, pulleys 154-1 to 154-4, and motors 155-1 to 155-4, respectively, so as to contact predetermined portions of contact object 101. One end of each of the wires 152-1 to 152-4 is fixed to a corresponding one of the tactile sensing pads 73-1 to 73-4, and the other end of each of the wires 152-1 to 152-4 is wound around a corresponding one of the pulleys 154-1 to 154-4. The pulleys 153-1 to 153-4 are each rotatably supported.

The wires 152-1 to 152-4 are respectively hung on pulleys 153-1 to 153-4 to change the extending directions of the wires 152-1 to 152-4. Pulleys 154-1 through 154-4 are rotated by motors 155-1 through 155-4, respectively. Each of the motors 155-1 to 155-4 is an electric motor. When pulleys 154-1 to 154-4 are rotated by motors 155-1 to 155-4, respectively, the lengths of wires 152-1 to 152-4 wound around pulleys 154-1 to 154-4, respectively, change, causing tactile sensing pads 73-1 to 73-4 fixed to one end of wires 152-1 to 152-4, respectively, to be pulled and displaced.

That is, the pulleys 154-1 to 154-4 are rotated by the motors 155-1 to 155-4, respectively, to wind up the wires 152-1 to 152-4, respectively, and the tactile sensing pads 73-1 to 73-4 are pulled by the wires 152-1 to 152-4, respectively, and pressed against the touch target 101.

For example, at a given time, pulley 154-2 is rotated by motor 155-2 and winds up wire 152-2, which in turn pulls and displaces tactile sensing pad 73-2, moving it toward contact object 101; pulleys 154-1, 154-3, and 154-4 do not move tactile sensing pads 73-1, 73-3, and 73-4 toward contact object 101, because motors 155-1, 155-3, and 155-4, respectively, are not rotating. At this time, the tactile sensing pad 73-2 detects force, pressure or vibration. That is, at this time, the tactile sensing pad 73-2 detects the unevenness or pattern of the contact object 101, or the force, pressure, or vibration applied to the contact object 101.

At a given time, all of tactile sensing pads 73-1 to 73-4, or any one or more of tactile sensing pads 73-1 to 73-4, are pulled by wires 152-1 to 152-4 respectively via pulleys 153-1 to 153-4 and pulleys 154-1 to 154-4 respectively, so that they are moved towards contact object 101 so as to contact a given portion of contact object 101, or all of tactile sensing pads 73-1 to 73-4 are moved away from contact object 101.

For example, the tactile sensing pads 73-1 to 73-4 are biased away from the contact target 101 by a spring or the like (not illustrated).

For example, the tactile sensing pad group 21 including the tactile sensing units 151-1 to 151-4 can be realized as a glove-type device.

Although the motors 155-1 to 155-4 have been described as being electric motors, the present invention is not limited to this and may be a pressure motor that utilizes the pressure of a fluid, a molecular motor, or an ultrasonic motor.

Hereinafter, when there is no need to distinguish between the tactile sensing units 151-1 to 151-4, they will simply be referred to as tactile sensing units 151. Hereinafter, when there is no need to distinguish between the wires 152-1 to 152-4, they will simply be referred to as wires 152. Moreover, when there is no need to distinguish between the pulleys 153-1 to 153-4, they will be simply referred to as pulleys 153. When there is no need to distinguish between the pulleys 154-1 to 154-4, they will be simply referred to as pulleys 154. Moreover, when there is no need to distinguish between the motors 155-1 to 155-4, they will be simply referred to as motors 155.

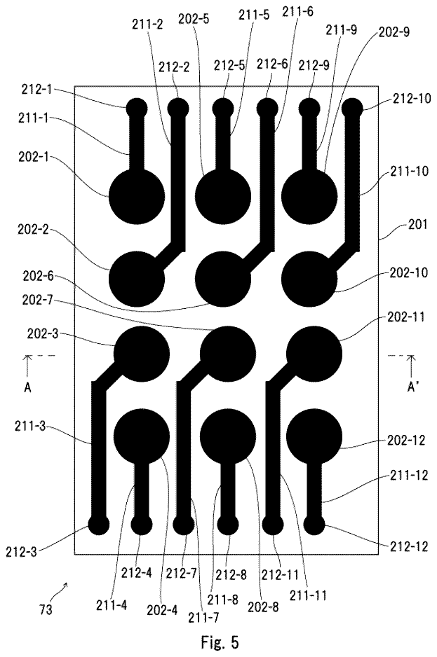

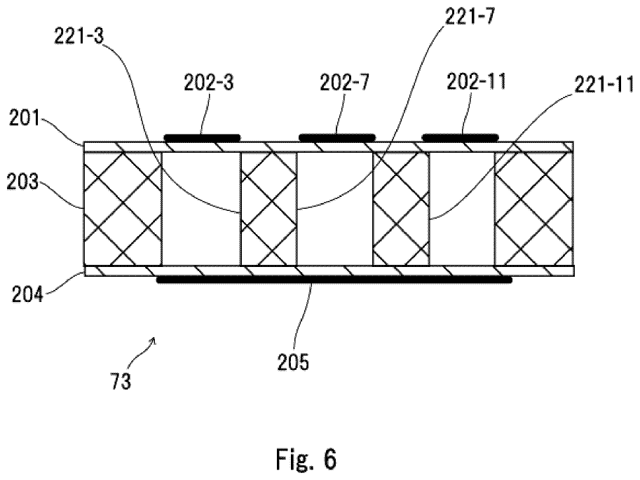

Next, an example of the detailed configuration of the tactile sensing pad 73 will be described. FIG. 5 is a plan view showing an example of the configuration of the tactile sensing pad 73. FIG. 6 is a cross-sectional view showing a cross section of the tactile sensing pad 73 taken along line AA′ in FIG. The tactile sensing pad 73 includes a film 201, electrodes 202-1 to 202-12, a dielectric member 203, a film 204, and an electrode 205. The thickness of the tactile sensing pad 73 is equal to or greater than 0.2 mm and less than 0.5 mm.

The tactile sensing pads 73 detect force, pressure or vibration. For example, the tactile sensing pad 73 generates a voltage signal corresponding to the magnitude of force, the distribution of pressure, or the amplitude or period of vibration.

The electrodes 202-1 to 202-12 are provided on one surface of the film 201. The electrode 205 is provided on one surface of the film 204. Of the surfaces of the dielectric member 203, the upper surface in FIG. 6 (hereinafter also simply referred to as the upper surface)) has the other surface of film 201 attached to the first surface. Among the surfaces of the dielectric member 203, a second surface (the lower surface in FIG. 6 (hereinafter, also simply referred to as the lower surface)) facing the first surface is )) has the other surface of the film 204 attached thereto. That is, the film 201 and the film 204 are bonded together with the dielectric member 203 sandwiched therebetween. For example, the planar shape of the film 201, the planar shape of the dielectric member 203, and the planar shape of the film 204 are the same. For example, the planar shape of the film 201, the planar shape of the dielectric member 203, and the planar shape of the film 204 are rectangular. For example, the film 201, the dielectric member 203, and the film 204 are attached to each other so as to overlap each other when viewed in the planar direction. The electrodes 202-1 to 202-12 are provided on the outer surface of the film 201 which is bonded to the film 204 with the dielectric member 203 sandwiched therebetween. The electrode 205 is provided on the outer surface of the film 204 which is bonded to the film 201 with the dielectric member 203 sandwiched therebetween.

The film 201 is an example of a first film, and is a film formed into a membrane shape from a polymer material.

The film 201 generates a voltage when a force, pressure or vibration is applied to it. The film 204 is an example of a second film, and is a film formed into a membrane shape from a polymer material. The film 204 generates a voltage when a force, pressure or vibration is applied to it. The film 201 and the film 204 are each a piezoelectric film such as PVDF (Polyvinylidene Difluoride) or a fluorine-based resin film such as FEP (Fluorinated Ethylene Propylene), PTFE (Poly Tetra Fluoro Ethylene), PFA (Per Fluoro Alkoxy polymer), ETFE (Ethylene Tetra Fluoro Ethylen copolymer), PVDF, PCTFE (Poly Chloro Tri Fluoro Ethylene), or ECTFE (Ethylene Chloro Tri Fluoro Ethylene copolymer). The material of film 204 may be the same as the material of film 201 or may be different.

The dielectric member 203 is a dielectric and insulator, and is molded into a thin plate shape using a flexible material. For example, the dielectric member 203 is made of rubber such as silicone rubber, PDMS (dimethylpolysiloxane), fluororubber, acrylic rubber, or urethane rubber. Dielectric member 203 is formed with holes 221-1 (not shown), 221-2 (not shown), 221-3, 221-4 (not shown) through 221-6 (not shown), 221-7, 221-8 (not shown) through 221-10 (not shown), 221-11 and 221-12 (not shown). The holes 221-1 to 221-12 penetrate the surface of the dielectric member 203 from the surface on the film 201 side to the surface on the film 204 side. That is, the holes 221-1 to 221-12 penetrate the dielectric member 203 from its upper surface to its lower surface. The top surface of the dielectric member 203 is an example of a first surface. The lower surface of the dielectric member 203 is an example of the second surface.

The electrodes 202-1 to 202-12 are made of a conductor and formed into a film shape. For example, the electrodes 202-1 to 202-12 are coatings made of metal materials such as gold (Au), platinum (Pt), titanium (Ti), or aluminum (Al), or carbon nanotube (CNT) electrode films. The electrodes 202-1 to 202-12 are formed to be flexible. The electrodes 202-1 to 202-12 are insulated from each other. For example, the electrodes 202-1 to 202-12 are each formed in the shape of a circular thin film on one surface of the film 201. For example, each of the electrodes 202-1 to 202-12 is formed in a circular shape with a diameter of 1 mm.

The electrodes 202-1 to 202-12 are detection points that detect force, pressure, or vibration, respectively. The spacing between electrodes 202-1 to 202-12 is set to be less than the two-point discrimination threshold of human skin. For example, when the tactile sensing pad 73 is used on the tip of a finger, the spacing between the electrodes 202-1 to 202-12 is set to less than 2 mm. In this case, the interval between the electrodes 202-1 to 202-12 refers to the distance from the center to the center of each of the circularly formed electrodes 202-1 to 202-12 or the distance from the outer edge to the outer edge of each of the circularly formed electrodes 202-1 to 202-12.

The terminals 212-1 to 212-12 are terminals for outputting voltages from the electrodes 202-1 to 202-12 through the wiring portions 211-1 to 211-12, respectively. The terminals 212-1 to 212-12 and the wiring portions 211-1 to 211-12 are formed from the same material as the electrodes 202-1 to 202-12.

Each of the terminals 212-1 to 212-12 is formed in the shape of a circular thin film. The wiring sections 211-1 to 211-12 are each made of a flat thin film that connects the terminals 212-1 to 212-12 and the electrodes 202-1 to 202-12, respectively, or are made of a plurality of flat thin films that are connected to each other.

For example, along one side of the film 201, the upper surface of which is rectangular in shape, terminals 212-1, 212-2, 212-5, 212-6, 212-9, and 212-10 are arranged. Terminals 212-3, 212-4, 212-7, 212-8, 212-11, and 212-12 are arranged along a side of the film 201 opposite to the side on which terminals 212-1, 212-2, 212-5, 212-6, 212-9, and 212-10 are arranged. For example, the terminals 212-1 to 212-12 are each electrically connected to the outside by wire bonding.

That is, a voltage is generated in each of the electrodes 202-1 to 202-12 due to pressure on the tactile sensing pad 73 or deformation of the tactile sensing pad 73. The voltages generated across the electrodes 202-1 through 202-12 are transmitted to the terminals 212-1 through 212-12, respectively.

The electrode 205 is made of a conductor and formed into a film shape. For example, the electrode 205 is a coating made of a metal material such as gold (Au), platinum (Pt), titanium (Ti) or aluminum (Al) or a carbon nanotube (CNT) electrode film. The electrode 205 is formed to be flexible. The electrode 205 is formed in the shape of a rectangular thin film on one surface of the film 204. The electrode 205 is formed so as to face all of the electrodes 202-1 to 202-12. That is, the electrode 205 is formed so as to sandwich all of the electrodes 202-1 to 202-12, the film 201, the dielectric member 203 and the film 204 therebetween. In other words, the electrode 205 is formed so as to overlap all of the electrodes 202-1 to 202-12 in the thickness direction of the film 201, the dielectric member 203, and the film 204.

The hole 221-3 is formed in a columnar shape having a circular cross section so as to be circular on the upper surface and the lower surface of the dielectric member 203. The end portion of the upper surface of the dielectric member 203 of the hole 221-3 coincides with the outer periphery of the electrode 202-3. The electrode 205 covers the end portion on the lower surface of the dielectric member 203 of the hole 221-3 on one surface of the film 204.

Moreover, the hole 221-7 is formed in a columnar shape with a circular cross section so that it is circular on the upper and lower surfaces of the dielectric member 203. The end of hole 221-7 on the top surface of dielectric member 203 coincides with the outer periphery of electrode 202-7. An electrode 205 is on one side of the film 204 and covers the end of the hole 221-7 at the lower surface of the dielectric member 203.

Furthermore, the holes 221-11 are formed in a columnar shape with a circular cross section so that they are circular on the upper and lower surfaces of the dielectric member 203. The end of hole 221-11 on the top surface of dielectric member 203 coincides with the outer periphery of electrode 202-11. An electrode 205 is on one side of the film 204 and covers the end of the hole 221-11 on the lower surface of the dielectric member 203.

Similarly, holes 221-1 and 221-2, holes 221-4 to 221-6, holes 221-8 to 221-10, and hole 221-12 are formed in the shape of a column with a circular cross section so as to form circles on the upper and lower surfaces of dielectric member 203. The ends of holes 221-1 and 221-2, holes 221-4 to 221-6, holes 221-8 to 221-10, and hole 221-12 on the upper surface of dielectric member 203 coincide with the outer circumferences of electrodes 202-1 and 202-2, electrodes 202-4 to 202-6, electrodes 202-8 to 202-10, and electrode 202-12, respectively. The electrode 205 is disposed on one surface of the film 204 and covers the ends of the holes 221-1 and 221-2, the holes 221-4 to 221-6, the holes 221-8 to 221-10, and the hole 221-12 on the lower surface of the dielectric member 203, respectively.

In this manner, any one of electrodes 202-1 to 202-12 and electrode 205 are disposed across films 201 and 204 to sandwich a portion of dielectric member 203 in which either hole 221-1 or hole 221-12 is formed.

The cross-sectional shapes of the holes 221-1 to 221-12 formed in the dielectric member 203 on the upper surface of the dielectric member 203 are similar to the shapes of the surfaces of the film-like electrodes 202-1 to 202-12, respectively.

Further, the electrodes 202-1 to 202-12 are disposed on the cross sections of the upper surface of the dielectric member 203, which are cross sections of the holes 221-1 to 221-12 formed in the dielectric member 203, with the film 201 sandwiched therebetween.

Before use, a voltage of 100 V to 15 KV is applied to the tactile sensing pad 73 to precharge it with an electric charge.

When a voltage is applied between the electrodes 202-1 to 202-12 and the electrode 205 as a precharge, charges are accumulated between the films 201 and 204, particularly in the holes 221-1 to 221-12 of the dielectric member 203. When pre-charged, the tactile sensing pads 73 generate a larger voltage with less force, pressure or vibration.

When force, pressure or vibration is applied to a specific portion or the entire tactile sensing pad 73, a voltage corresponding to the applied force, pressure or vibration is generated between electrode 205 and all or any of electrodes 202-1 to 202-12. For example, when force, pressure or vibration is applied to a specific portion or the entire tactile sensing pad 73, a voltage corresponding to the magnitude of the force, pressure or vibration is generated between all or any of electrodes 202-1 to 202-12 and electrode 205.

The tactile sensing pad 73 is mainly made of resin or silicone rubber, and can be easily deformed to fit the contact object 101 and detect the force, pressure, or vibration caused by the movement of the contact object 101 or the force, pressure, or vibration applied to the contact object 101.

When the ratio of the area of the holes 221-1 to 221-12 to the total area of the dielectric member 203 is between 10% and 40%, the tactile sensing pad 73 generates a larger voltage with a smaller force, pressure or vibration.

Although holes 221-1 to 221-12 have been described as penetrating from the top surface to the bottom surface of dielectric member 203, they may not penetrate from the top surface to the bottom surface of dielectric member 203, but may have a shape recessed from the top surface or bottom surface of dielectric member 203, and further, they may be bubble-shaped holes inside dielectric member 203.

Also, although the electrodes 202-1 to 202-12 have been described as being formed as circular thin films on one surface of the film 201, they may be elliptical, oval, or polygonal, such as triangular or rectangular.

As described above, it is possible to detect force, pressure or vibration applied to all or any of the electrodes 202-1 to 202-12.

Hereinafter, when there is no need to distinguish between the electrodes 202-1 to 202-12, they will be simply referred to as electrodes 202. Hereinafter, when there is no need to distinguish between the holes 221-1 to 221-12, they will simply be referred to as holes 221.

In addition, the material for forming the dielectric member 203 may be added with approximately 0.1% by weight to 30% by weight of a storage agent such as MOF (Metal Organic Frameworks) materials such as graphene, carbon nanotubes, barium titanate, potassium, zinc oxide, MXene, Zn₂TTFTB and Cd₂TTBFT, Ni3_{</sub>}(2,3,6,7,10,11-hexaiminotriphenylene)₂ [Ni₃ (HITP)₂], Zr—UiO-66, and ZIF-67, thereby assisting in the accumulation of electric charge in the dielectric member 203.

In addition, the holes 221 may be filled with 0.5% to 50% by volume of a charge storage material such as graphene, carbon nanotubes, barium titanate, potassium, zinc oxide, MXene, or MOF material to assist in the accumulation of charges.

In addition, when a capacitor such as MOF materials such as MXene, Zn₂ TTFTB and Cd₂ TTBFT, Ni₃ (2, 3, 6, 7, 10, 11-hexaiminotriphenylene)₂ [Ni₃ (HITP)₂], Zr—UiO-66, and ZIF-67 is mixed into the dielectric member 203 or placed in the hole 221, the tactile sensing pad 73 can be used without being charged with an electric charge in advance.

In addition, when molding the dielectric member 203, a foaming agent may be mixed in an amount of 0.1% by weight to 5% by weight to create air bubbles inside the dielectric member 203, thereby forming the holes 221 in the dielectric member 203.

Human skin has numerous receptors for sensing vibration, shape, and shear force. By detecting forces, pressures, or vibrations in contact with target object 101, tactile sensing pad 73 can generate voltages corresponding to the forces, pressures, or vibrations that activate skin receptors, enabling the generation of voltages corresponding to tactile and pressure sensations. In other words, tactile sensing pad 73 can detect the forces, pressures, or vibrations applied to target object 101 that activate skin receptors, as well as forces, pressures, or vibrations that generate tactile and pressure sensations.

By using the voltage obtained from tactile sensing pad 73 as a signal representing the force, pressure, or vibration that activates skin receptors, a device that applies stimuli to the skin can reproduce the tactile, pressure, or vibration sensations applied to human skin.

As described with reference to FIGS. 2 to 4, when tactile sensing pad 73 is pressed against contact object 101 by air actuator 72, cam 122 and motor 123, or wire 152, pulley 153, pulley 154 and motor 155, and force, pressure or vibration is applied to all or any of electrodes 202-1 to 202-12, tactile sensing pad 73 generates a voltage between all or any of electrodes 202-1 to 202-12 and electrode 205 according to the magnitude of the force, pressure or vibration.

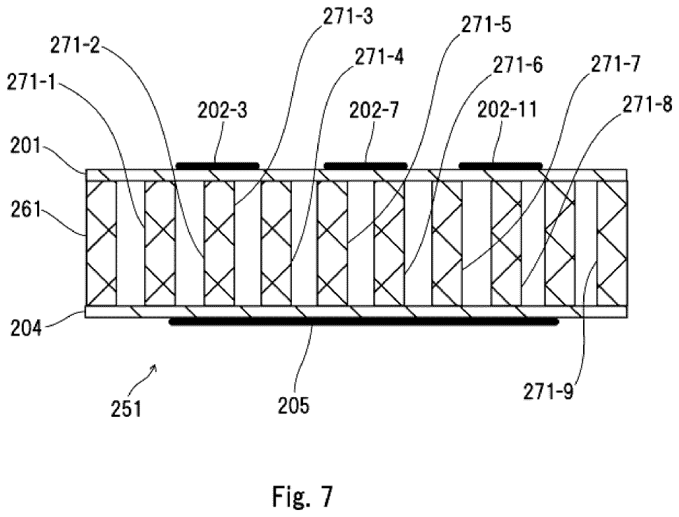

Next, a detailed example of the configuration of the tactile sensing pad 251 that constitutes the tactile sensing pad group 21 will be described. The tactile sensing pad 251 is used in the tactile sensing pad group 21 in the same manner as the tactile sensing pad 73 . FIG. 7 is a cross-sectional view showing a cross section of the tactile sensing pad 251. In FIG. 7, the same parts as those shown in FIG. 6 are denoted by the same reference numerals, and the description thereof will be omitted.

Tactile sensing pad 251 detects forces, pressure, or vibration. For example, it generates a voltage signal corresponding to the magnitude of the force, pressure distribution, or amplitude or period of vibration.

The tactile sensing pad 251 includes a film 201, electrodes 202-1 to 202-12, a film 204, an electrode 205, and a dielectric member 261. The thickness of the tactile sensing pad 251 is equal to or greater than 0.2 mm and less than 0.5 mm.

Of the surfaces of the dielectric member 261, the upper surface in FIG. 7 (hereinafter also simply referred to as the upper surface) has the other surface of film 201 attached to the first surface. Among the surfaces of the dielectric member 261, a second surface (the lower surface in FIG. 7 (hereinafter, also simply referred to as the lower surface) ) facing the first surface is has the other surface of the film 201 attached thereto. That is, the film 201 and the film 204 are bonded together with the dielectric member 261 sandwiched therebetween. For example, the planar shape of the film 201, the planar shape of the dielectric member 261, and the planar shape of the film 204 are the same. For example, the planar shape of the film 201, the planar shape of the dielectric member 261, and the planar shape of the film 204 are rectangular. For example, the film 201, the dielectric member 261, and the film 204 are attached to each other so as to overlap each other when viewed in the planar direction.

The dielectric member 261 is a dielectric and insulator, and is molded into a thin plate shape using a flexible material. For example, the dielectric member 261 is made of rubber such as silicone rubber, PDMS, fluororubber, acrylic rubber, or urethane rubber. The dielectric member 261 has holes 271-1 to 271-9 formed therein. The holes 271-1 to 271-9 penetrate the dielectric member 261 from its upper surface to its lower surface. Although FIG. 7 shows cross sections of electrodes 202-3, 202-7, and 202-11, holes similar to holes 271-1 to 271-9 are also formed in the portions of dielectric member 261 between electrodes 202-1, 202-5, 202-9, 202-2, 202-6, and 202-10, and between electrodes 202-4, 202-8, and 202-12 and electrode 205.

The electrode 205 is formed so as to overlap all of the electrodes 202-1 to 202-12 in the thickness direction of the film 201, the dielectric member 261 and the film 204.

The holes 271-1 to 271-9 are each formed in a columnar shape with a circular cross section so as to be circular on the upper and lower surfaces of the dielectric member 261. The diameter of the bottom surface of each of the holes 271-1 to 271-9 is smaller than the diameter of each of the electrodes 202-3, 202-7, and 202-11. Electrode 202-3 is disposed on one surface of film 201 so as to cover holes 271-2 and 271-3. Electrode 202-7 is disposed on one surface of film 201 so as to cover hole 271-5. Electrode 202-11 is disposed on one surface of film 201 so as to cover holes 271-7 and 271-8. That is, each of the electrodes 202-3, 202-7 and 202-11 is disposed on one surface of the film 201 so as to cover one or two of the holes 271-1 to 271-9. An electrode 205 is disposed on one surface of the film 204 and covers the ends of the holes 271-1 to 271-9 on the lower surface of the dielectric member 261.

Moreover, holes 271-1, 271-4, 271-6 and 271-9 are formed in portions of dielectric member 261 that are not sandwiched between electrodes 202-1 to 202-12 and electrode 205.

In this manner, each of the electrodes 202-3, 202-7, and 202-11 is disposed so as to cover one or two of the holes 271-1 through 271-9. That is, the electrodes 202-3, 202-7 and 202-11 are disposed on the cross sections of the upper surface of the dielectric member 261 through the film 201, of the holes 271-2, 271-3, 271-5, 271-7 and 271-8 formed in the dielectric member 261.

Before use, a voltage of 100V to 15KV is applied to the tactile sensing pad 251 to precharge it with an electric charge.

When a voltage is applied between electrodes 202-1 through 202-12 and electrode 205 as a precharge, charge is accumulated between films 201 and 204, particularly in holes in dielectric member 261 similar to holes 271-1 through 271-9 and holes 271-1 through 271-9. When pre-charged, the tactile sensing pads 251 generate a larger voltage with less force, pressure or vibration.

When force, pressure or vibration is applied to a predetermined portion or the entire tactile sensing pad 251, a voltage corresponding to the force, pressure or vibration is generated between the electrode 205 and all or any of the electrodes 202-1 to 202-12. For example, when force, pressure or vibration is applied to a specific portion or the entire tactile sensing pad 251, a voltage corresponding to the magnitude of the force, pressure or vibration is generated between all or any of electrodes 202-1 to 202-12 and electrode 205.

The tactile sensing pad 251 is mainly made of resin or silicone rubber, and can be easily deformed to fit the contact object 101, thereby detecting the force, pressure, or vibration caused by the movement of the contact object 101 or the force, pressure, or vibration applied to the contact object 101.

When the ratio of the area of holes 271-1 to 271-9 and holes similar to holes 271-1 to 271-9 to the total area of dielectric member 261 is between 10% and 40%, tactile sensing pad 251 generates a larger voltage with less force, pressure or vibration.

It should be noted that, although holes 271-1 to 271-9 and holes similar to holes 271-1 to 271-9 have been described as penetrating from the top surface to the bottom surface of dielectric member 261, they may not penetrate from the top surface to the bottom surface of dielectric member 261, but may have a shape recessed from the top surface or bottom surface of dielectric member 261, and further, may be bubble-shaped holes inside dielectric member 261.

Hereinafter, when there is no need to distinguish between the holes 271-1 to 271-9, they will simply be referred to as holes 271.

In addition, the material used to form the dielectric member 261 may be added with approximately 0.1% by weight to 30% by weight of a storage agent such as MOF (Metal Organic Frameworks) materials such as graphene, carbon nanotubes, barium titanate, potassium, zinc oxide, MXene, Zn₂ TTFTB and Cd₂ TTBFT, Ni₃ (2,3,6,7,10,11-hexaiminotriphenylene)₂ [Ni₃(HITP)₂], Zr—UiO-66, and ZIF-67 is added to about 0.1 wt. % to 30 wt. %, and the accumulation of electric charges of the dielectric member 261 can be assisted.

In addition, the holes 271 may be filled with 0.5% to 50% by volume of a charge storage material such as graphene, carbon nanotubes, barium titanate, potassium, zinc oxide, MXene, or MOF material to assist in the accumulation of charges.

In addition, when a capacitor such as MOF materials such as MXene, Zn₂ TTFTB and Cd₂ TTBFT, Ni₃ (2, 3, 6, 7, 10, 11-hexaiminotriphenylene)₂ [Ni₃ (HTTP)₂], Zr—UiO-66, and ZIF-67 is mixed into the dielectric member 261 or placed in the hole 271, the tactile sensing pad 251 can be used without being charged with an electric charge in advance.

In addition, when molding the dielectric member 261, a foaming agent may be mixed in an amount of 0.1 to 5% by weight to create air bubbles inside the dielectric member 261, thereby forming the holes 271 in the dielectric member 261.

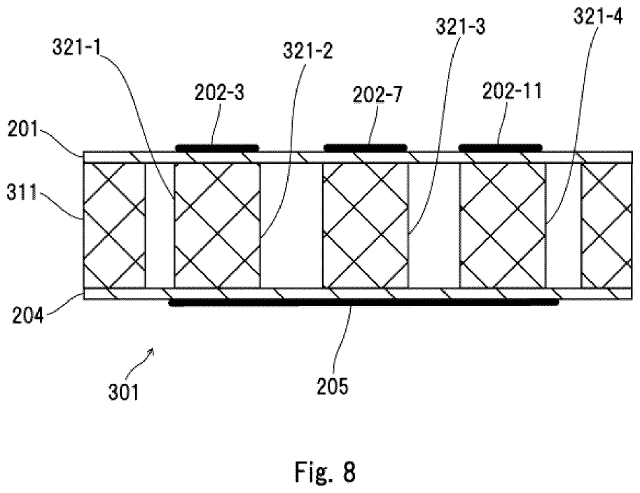

Next, a detailed example of the configuration of the tactile sensing pad 301 that constitutes the tactile sensing pad group 21 will be described. The tactile sensing pad 301 is used in the same manner as the tactile sensing pad 73 in the tactile sensing pad group 21. FIG. 8 is a cross-sectional view showing a cross section of the tactile sensing pad 301. In FIG. 8, the same parts as those shown in FIG. 6 are denoted by the same reference numerals, and the description thereof will be omitted.

The tactile sensing pad 301 detects force, pressure, or vibration. For example, the tactile sensing pad 301 generates a voltage signal corresponding to the magnitude of force, the distribution of pressure, or the amplitude or period of vibration.

The tactile sensing pad 301 includes a film 201, electrodes 202-1 to 202-12, a film 204, an electrode 205, and a dielectric member 311. The thickness of the tactile sensing pad 301 is equal to or greater than 0.2 mm and less than 0.5 mm.

Of the surfaces of the dielectric member 311, the upper surface in FIG. 8 (hereinafter also simply referred to as the upper surface) has the other surface of film 201 attached to the first surface. Among the surfaces of the dielectric member 311, a second surface (the lower surface in FIG. 8 (hereinafter, also simply referred to as the lower surface)) facing the first surface is) has the other surface of the film 201 attached thereto. That is, the film 201 and the film 204 are attached to each other with the dielectric member 311 sandwiched therebetween. For example, the planar shape of the film 201, the planar shape of the dielectric member 311, and the planar shape of the film 204 are the same. For example, the planar shape of the film 201, the planar shape of the dielectric member 311, and the planar shape of the film 204 are rectangular. For example, the film 201, the dielectric member 311, and the film 204 are attached to each other so as to overlap each other when viewed in the planar direction.

The dielectric member 311 is a dielectric and insulator, and is molded into a thin plate shape using a flexible material. For example, the dielectric member 311 is made of rubber such as silicone rubber, PDMS, fluororubber, acrylic rubber, or urethane rubber. The dielectric member 311 has holes 321-1 to 321-4 formed therein. The holes 321-1 to 321-4 penetrate the dielectric member 311 from its upper surface to its lower surface. Although FIG. 8 shows cross sections of electrodes 202-3, 202-7, and 202-11, holes similar to holes 321-1 to 321-4 are also formed in the portions of dielectric member 311 between electrodes 202-1, 202-5, 202-9, 202-2, 202-6, and 202-10, and between electrodes 202-4, 202-8, and 202-12 and electrode 205.

The electrode 205 is formed so as to overlap all of the electrodes 202-1 to 202-12 in the thickness direction of the film 201, the dielectric member 311 and the film 204.

The holes 321-1 to 321-4 are each formed in a columnar shape with a circular cross section so as to be circular on the upper and lower surfaces of the dielectric member 311. Hole 321-1 is formed between the left end side of dielectric member 311 in FIG. 8 and the portion sandwiched between electrode 202-3 and electrode 205. Hole 321-2 is formed between the portion sandwiched between electrode 202-3 and electrode 205 and the portion sandwiched between electrode 202-7 and electrode 205. The hole 321-3 is formed between the portion sandwiched between the electrodes 202-7 and 205 and the portion sandwiched between the electrodes 202-11 and 205. Hole 321-4 is formed between the portion sandwiched between electrode 202-7 and electrode 205 and the right end side of dielectric member 311 in FIG. 8.

In this manner, the electrodes 202-3, 202-7, and 202-11, and the electrode 205 are arranged to sandwich the portion of the dielectric member 311 that is separate from the portion in which the holes 321-1 to 321-4 are formed. In other words, the electrodes 202-3, 202-7, and 202-11, and the electrode 205 are arranged to sandwich the portion of the dielectric member 311 in which the holes 321-1 to 321-4 are not formed.

The holes 321-1 to 321-4 are formed in the dielectric member 311 in a portion that is not sandwiched between the electrodes 202-1 to 202-12 and the electrode 205.

Before use, a voltage of 100V to 15KV is applied to the tactile sensing pad 301 to precharge it with an electric charge.

When a voltage is applied as a precharge between electrodes 202-1 to 202-12 and electrode 205, charges are accumulated between films 201 and 204, particularly in holes 321-1 to 321-4 of dielectric member 311 and holes similar to holes 321-1 to 321-4. The pre-charging of the electric charge causes the tactile sensing pad 301 to generate a larger voltage with less force, pressure or vibration.

When force, pressure or vibration is applied to a predetermined portion or the entire tactile sensing pad 301, a voltage corresponding to the force, pressure or vibration is generated between the electrode 205 and all or any of the electrodes 202-1 to 202-12. For example, when force, pressure or vibration is applied to a specific portion or the entire tactile sensing pad 301, a voltage corresponding to the magnitude of the force, pressure or vibration is generated between all or any of electrodes 202-1 to 202-12 and electrode 205.

The tactile sensing pad 301 is mainly made of resin or silicone rubber, and can be easily deformed to fit the contact object 101, thereby detecting the force, pressure, or vibration caused by the movement of the contact object 101 or the force, pressure, or vibration applied to the contact object 101.

When the ratio of the area of holes 321-1 to 321-4 and holes similar to holes 321-1 to 321-4 to the total area of dielectric member 311 is between 10% and 40%, tactile sensing pad 301 generates a larger voltage with less force, pressure or vibration.

It should be noted that, although holes 321-1 to 321-4 and holes similar to holes 321-1 to 321-4 have been described as penetrating from the top surface to the bottom surface of dielectric member 311, they may not penetrate from the top surface to the bottom surface of dielectric member 311, but may have a shape recessed from the top surface or bottom surface of dielectric member 311, and further, may be bubble-shaped holes inside dielectric member 311.

Hereinafter, when there is no need to distinguish between the holes 321-1 to 321-4, they will simply be referred to as holes 321.

In addition, the material used to form the dielectric member 311 may be added with approximately 0.1% by weight to 30% by weight of a storage agent such as MOF (Metal Organic Frameworks) materials such as graphene, carbon nanotubes, barium titanate, potassium, zinc oxide, MXene, Zn₂ TTFTB, Cd₂ TTBFT, Ni₃ (2, 3, 6, 7, 10, 11-hexaiminotriphenylene))₂ [Ni₃ (HITP)₂], Zr—UiO-66, and ZIF-67, thereby assisting in the accumulation of electric charge in the dielectric member 311.

In addition, the holes 321 may be filled with 0.5% to 50% by volume of a charge storage material such as graphene, carbon nanotubes, barium titanate, potassium, zinc oxide, MXene, or MOF material to assist in the accumulation of charges.

In addition, when a capacitor such as MOF materials such as MXene, Zn₂ TTFTB, Cd₂ TTBFT, Ni₃ (2,3,6,7,10,11-hexaiminotriphenylene)₂ [Ni₃ (HITP)₂], Zr—UiO-66, ZIF-67, etc. is mixed into the dielectric member 311 or placed in the hole 321, the tactile sensing pad 301 can be used without being charged with an electric charge in advance.

In addition, when molding the dielectric member 311, a foaming agent may be mixed in an amount of 0.1 to 5% by weight to create air bubbles inside the dielectric member 311, thereby forming holes 321 in the dielectric member 311.

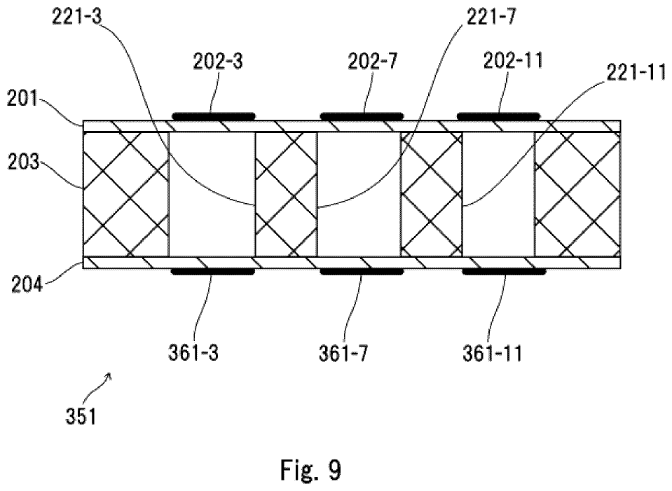

Next, a detailed example of the configuration of the tactile sensing pad 351 that constitutes the tactile sensing pad group 21 will be described. The tactile sensing pad 351 is used in the same manner as the tactile sensing pad 73 in the tactile sensing pad group 21. FIG. 9 is a cross-sectional view showing a cross section of the tactile sensing pad 351. In FIG. 9, the same parts as those shown in FIG. 6 are denoted by the same reference numerals, and the description thereof will be omitted.

The tactile sensing pad 351 detects force, pressure or vibration. For example, the tactile sensing pad 351 generates a voltage signal corresponding to the magnitude of force, the distribution of pressure, or the amplitude or period of vibration.

The tactile sensing pad 351 includes a film 201, electrodes 202-1 to 202-12, a dielectric member 203, a film 204, and electrodes 361-1 to 361-12. The thickness of the tactile sensing pad 351 is equal to or greater than 0.2 mm and less than 0.5 mm.

FIG. 9 shows cross sections of electrodes 202-3, 202-7, and 202-11, as well as electrodes 361-3, 361-7, and 361-7. However, a hole 321-1 is formed in a portion of dielectric member 311 between electrodes 202-1 and 361-1 (not shown), a hole 321-2 is formed in a portion of dielectric member 311 between electrodes 202-2 and 361-2 (not shown), and similarly, a hole 321-3 is formed in a portion of dielectric member 311 between electrodes 202-4 to 202-6 and electrode 361-4 (not shown). Holes 321-4 to 321-4 are formed in the portions of dielectric member 311 between electrodes 202-8 to 202-10 and electrodes 361-8 (not shown) to 361-10 (not shown), respectively, holes 321-8 to 321-10 are formed in the portions of dielectric member 311 between electrodes 202-12 and 361-12 (not shown).

Each of the electrodes 361-1 to 361-12 is formed into a film shape made of a conductor. For example, each of the electrodes 361-1 to 361-12 is a coating made of a metal material such as gold (Au), platinum (Pt), titanium (Ti), or aluminum (Al), or a carbon nanotube (CNT) electrode film. The electrodes 361-1 to 361-12 are formed to be flexible.

The electrodes 361-1 to 361-12 are insulated from each other. For example, the electrodes 361-1 to 361-12 are each formed in the shape of a circular thin film on one surface of the film 204. For example, each of the electrodes 361-1 to 361-12 is formed in a circular shape with a diameter of 1 mm. Each of the electrodes 361-1 to 361-12 is provided with a wiring portion and a terminal, similar to each of the electrodes 202-1 to 202-12.

The electrodes 361-1 to 361-12 are formed so as to face the electrodes 202-1 to 202-12, respectively. The electrodes 361-1 to 361-12 are formed so as to sandwich the film 201, the dielectric member 203 and the film 204 with the electrodes 202-1 to 202-12, respectively. The electrode 361-1 is disposed at a position opposite to the electrode 202-1, with the film 201, the dielectric member 203 and the film 204 interposed therebetween. The electrode 361-2 is disposed at a position opposite to the electrode 202-2, with the film 201, the dielectric member 203 and the film 204 interposed therebetween. Similarly, the electrodes 361-3 to 361-12 are formed at positions facing the electrodes 202-3 to 202-12, respectively, with the film 201, the dielectric member 203, and the film 204 interposed therebetween.

In other words, the electrodes 361-1 to 361-12 are formed at positions facing the electrodes 202-1 to 202-12, respectively, in the thickness direction of the film 201, the dielectric member 203, and the film 204.

The end of hole 221-3 on the lower surface of dielectric member 203 coincides with the outer periphery of electrode 361-3. An electrode 361-3 is disposed on one surface of the film 204 and covers the end of the hole 221-3 at the lower surface of the dielectric member 203. Furthermore, the end of hole 221-7 on the lower surface of dielectric member 203 coincides with the outer periphery of electrode 361-7. An electrode 361-7 is provided on one surface of the film 204 and covers the end of the hole 221-7 at the lower surface of the dielectric member 203. Furthermore, the end of hole 221-11 on the lower surface of dielectric member 203 coincides with the outer periphery of electrode 361-11. An electrode 361-11 is disposed on one surface of the film 204 and covers the end of the hole 221-11 at the lower surface of the dielectric member 203.

The ends of holes 221-1 and 221-2, holes 221-4 to 221-6, holes 221-8 to 221-10, and hole 221-12 on the lower surface of dielectric member 203 respectively coincide with the outer circumferences of electrodes 361-1 and 361-2, electrodes 361-4 to 361-6, electrodes 361-8 to 361-10, and electrode 361-12. On one surface of the film 204, electrodes 361-1 and 361-2, electrodes 361-4 to 361-6, electrodes 361-8 to 361-10, and electrode 361-12 cover the ends of holes 221-1 and 221-2, holes 221-4 to 221-6, holes 221-8 to 221-10, and hole 221-12 on the lower surface of the dielectric member 203, respectively.

In this manner, each of electrodes 202-1 to 202-12 and each of electrodes 361-1 to 361-12 are arranged to sandwich films 201 and 204, and to sandwich the portions of dielectric member 203 in which holes 221-1 and holes 221-12 are formed, respectively.

Before use, a voltage of 100V to 15KV is applied to the tactile sensing pad 351 to precharge it with an electric charge.

When a voltage is applied as a precharge between the electrodes 202-1 through 202-12 and the electrodes 361-1 through 361-12, charges are accumulated between the films 201 and 204, particularly in the holes 221-1 through 221-12 of the dielectric member 203. When pre-charged, the tactile sensing pads 351 generate a larger voltage with less force, pressure or vibration.

When force, pressure or vibration is applied to a specific portion or the entire tactile sensing pad 351, a voltage corresponding to the force, pressure or vibration is generated between electrode 202-1 and electrode 361-1 and/or between electrode 202-12 and electrode 361-12. For example, when force, pressure or vibration is applied to a specific portion or the entire tactile sensing pad 351, a voltage corresponding to the magnitude of the force, pressure or vibration is generated between all or any of electrodes 202-1 and 361-1 and/or between electrodes 202-12 and 361-12.

The tactile sensing pad 351 is mainly made of resin or silicone rubber, and can be easily deformed to fit the contact object 101 and detect force, pressure, or vibration caused by the movement of the contact object 101 or force, pressure, or vibration applied to the contact object 101.

When the ratio of the area of the holes 221-1 to 221-12 to the total area of the dielectric member 203 is between 10% and 40%, the touch sensing pad 351 generates a larger voltage with a smaller force, pressure or vibration.

Hereinafter, when there is no need to distinguish between the electrodes 361-1 to 361-12, they will be simply referred to as electrodes 361.

In addition, when a capacitor such as MOF materials such as MXene, Zn₂ TTFTB, Cd₂ TTBFT, Ni₃ (2,3,6,7,10,11-hexaiminotriphenylene)₂ [Ni₃ (HIP)₂], Zr—UiO-66, ZIF-67, etc is mixed into the dielectric member 203 or placed in the hole 221, the tactile sensing pad 351 can be used without being charged with an electric charge in advance.

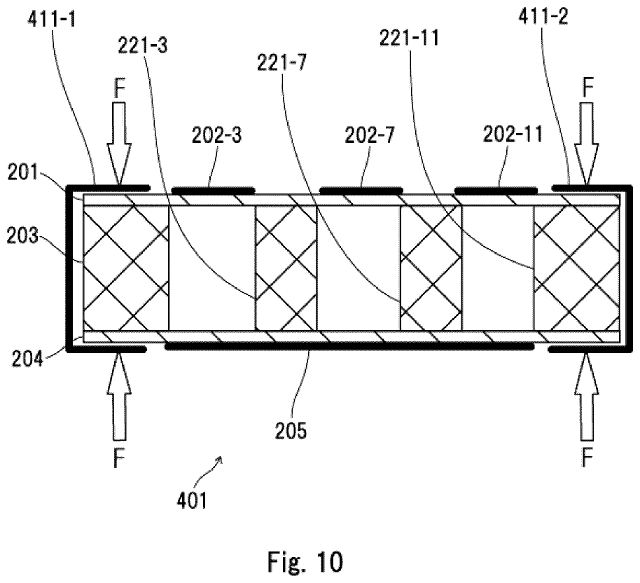

Next, a detailed example of the configuration of the tactile sensing pad 401 that constitutes the tactile sensing pad group 21 will be described. The tactile sensing pad 401 is used in the same manner as the tactile sensing pad 73 in the tactile sensing pad group 21. FIG. 10 is a cross-sectional view showing a cross section of the tactile sensing pad 401. In FIG. 10, the same parts as those shown in FIG. 6 are denoted by the same reference numerals, and the description thereof will be omitted.

The tactile sensing pad 401 detects force, pressure or vibration. For example, the tactile sensing pad 401 generates a voltage signal corresponding to the magnitude of force, the distribution of pressure, or the amplitude or period of vibration.

The tactile sensing pad 401 includes a film 201, electrodes 202-1 to 202-12, a dielectric member 203, a film 204, an electrode 205, and springs 411-1 and 411-2. The thickness of the tactile sense generating pad 411 is equal to or greater than 0.2 mm and less than 0.5 mm. The springs 411-1 and 411-2 are made of a spring material and have a U-shaped cross section. The spring 411-1 pinches and presses the left ends of the film 201, the dielectric member 203 and the film 204 in FIG. 10. The spring 411-2 pinches and presses the right-side ends of the film 201, the dielectric member 203 and the film 204 in the direction indicated by F in FIG. 10 with a force of 10 mN to 0.5 N. When spring 411-1 and spring 411-2 sandwich the opposing ends of film 201, dielectric member 203 and film 204, a preload can be applied uniformly to film 201, dielectric member 203 and film 204 as a whole.

In this manner, spring 411-1 and spring 411-2 pinch and press the ends of film 201, dielectric member 203 and film 204. In this way, a larger voltage can be generated with less force, pressure or vibration.

The springs 411-1 and 411-2 can be made of a metal material or resin. In addition, while it has been described that springs 411-1 and 411-2 sandwich the opposing ends of film 201, dielectric member 203, and film 204, this is not limited to the above, and a configuration in which screws such as bolts and nuts, or clips can be used to sandwich and press the ends can also be adopted.

Before use, a voltage of 100V to 15KV is applied to the tactile sensing pad 401 to precharge it with an electric charge.

When a voltage is applied between the electrodes 202-1 to 202-12 and the electrode 205 as a precharge, charges are accumulated between the films 201 and 204, particularly in the holes 221-1 to 221-12 of the dielectric member 203. When pre-charged, the tactile sensing pad 401 generates a larger voltage with less force, pressure or vibration.

When force, pressure or vibration is applied to a predetermined portion or the entire tactile sensing pad 401, a voltage corresponding to the force, pressure or vibration is generated between the electrode 205 and all or any of the electrodes 202-1 to 202-12. For example, when force, pressure or vibration is applied to a specific portion or the entire tactile sensing pad 401, a voltage corresponding to the magnitude of the force, pressure or vibration is generated between all or any of electrodes 202-1 to 202-12 and electrode 205.

The tactile sensing pad 401 is mainly made of resin or silicone rubber, and can be easily deformed to fit the contact object 101, thereby detecting the force, pressure, or vibration caused by the movement of the contact object 101 or the force, pressure, or vibration applied to the contact object 101.

When the ratio of the area of the holes 221-1 to 221-12 to the total area of the dielectric member 203 is between 10% and 40%, the tactile sensing pad 401 generates a larger voltage with a smaller force, pressure or vibration.

In addition, when a capacitor such as MOF materials such as MXene, Zn₂ TTFTB, Cd₂ TTBFT, Ni₃ (2,3,6,7,10,11-hexaiminotriphenylene)₂ [Ni₃ (HIP)₂], Zr—UiO-66, ZIF-67, etc. is mixed into the dielectric member 203 or placed in the hole 221, the tactile sensing pad 401 can be used without being charged with an electric charge in advance.

Next, an example of using the tactile sensing pad 73 as a sensor attached to the finger pad will be described.

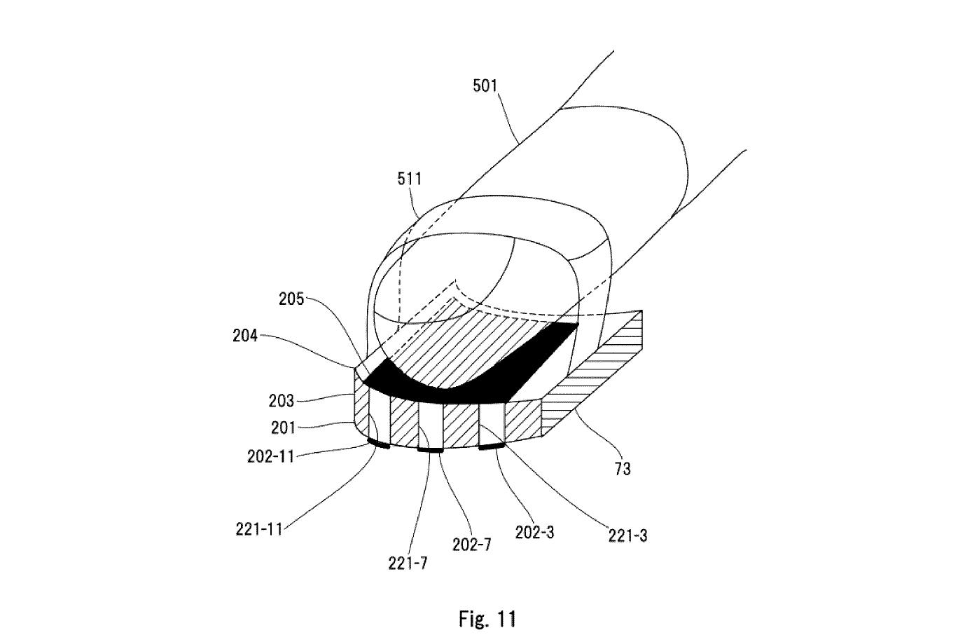

FIG. 11 is a diagram showing the state of the tactile sensing pad 73 attached to the finger pad. The touch sensing pad 73 is attached to the finger 501 with a fixing band 511 so that the surface on the electrode 205 side contacts the finger pad of the finger 501 and the surface on the electrodes 202-1 to 202-12 side contacts the touch target 10. The touch sensing pad 73 may be attached to the finger 501 so that the surface on the side of the electrodes 202-1 to 202-12 contacts the finger pad of the finger 501 and the surface on the side of the electrode 205 contacts the touch target 101.

For example, the tactile sensing pad 73 as a device to be worn on the finger pad is approximately the same size as the finger 501, and its thickness is greater than or equal to 0.2 mm and less than 0.5 mm. The tactile sensing pad 73 is thin and flexible, so that it fits the shape of the finger 501.

When the tactile sensing pad 73 is pressed against the contact object 101 with the finger 501 and a force, pressure or vibration is applied to a specific part or the whole, a voltage corresponding to the force, pressure or vibration is generated between all or any of the electrodes 202-1 to 202-12 and the electrode 205. In this manner, the tactile sensing pad 73 can detect force, pressure or vibration applied to the touch object 101.

In this manner, the tactile sensing pad 73 can be used alone as a sensor.

Alternatively, a thin glass plate may be doped with potassium, charged with an electric charge, and sandwiched between the dielectric member 203, the dielectric member 261 or the dielectric member 311 and the film 201 or the film 204. Alternatively, the dielectric member 203, the dielectric member 261 or the dielectric member 311 may be formed by doping 0.01 mm to 0.05 mm silica beads with potassium, mixing them with silicone rubber, and charging them with an electric charge.

Although it has been described that hole 221, hole 271 or hole 321 is formed in a cylindrical shape with a circular cross-section, the hole is not limited to this and may have any shape, such as an elliptical cylinder, an oblong cylinder, a polygonal cylinder such as a triangular prism or a rectangular prism, and the cross-sectional shape may change in the thickness direction of dielectric member 203, dielectric member 261 or dielectric member 311.

In this way, they can be made thinner, more flexible, and more sensitive to detecting force, pressure or vibration.

Also, wearable devices can detect force, pressure or vibration with greater sensitivity.

For example, force, pressure or vibration that causes a perception of vibration, a shock sensation, a pressure of force, an object's shape such as an edge or bump shape or a vibration pattern can be detected and a voltage generated in response.

In this way, tactile sensing pad group 21 uses one or more tactile sensing pads 73, tactile sensing pad 251, tactile sensing pad 301, tactile sensing pad 351 or tactile sensing pad 401, and each of tactile sensing pad 73, tactile sensing pad 251, tactile sensing pad 301, tactile sensing pad 351 or tactile sensing pad 401 is composed of a piezoelectric film or a fluorine-based film and silicone rubber or the like, and the piezoelectric film or fluorine-based film has electrodes of a predetermined pattern formed thereon for outputting a voltage corresponding to the applied force, pressure or vibration, and a voltage is output independently from each electrode. In order to impart piezoelectricity to tactile sensing pad 73, tactile sensing pad 251, tactile sensing pad 301, tactile sensing pad 351, or tactile sensing pad 401, a voltage is charged between the piezoelectric film or fluorine-based film to retain static electricity, and a bias frequency voltage is applied to this to generate a voltage corresponding to the applied force, pressure, or vibration.

As described above, the tactile sensing pad 73 is a sensor. The film 201 generates a voltage when a force, pressure or vibration is applied to it. A plurality of electrodes 202 are provided in the form of a film on one surface of the film 201. The electrodes 202 are spaced apart from one another by a predetermined distance. The film 204 generates a voltage when a force, pressure or vibration is applied to it. The electrode 205 is provided in the form of a film on one surface of the film 204. The dielectric member 203 is made of dielectric rubber and has a thin plate shape with holes formed therein. The dielectric member 203 has the other surface of the film 201 attached to a first surface, which is a predetermined surface, and the other surface of the film 204 attached to a second surface opposite the first surface. Holes 221-1 through 221-12 formed in the dielectric member 203 are filled with a capacitor material that assists in the accumulation of electric charges. The tactile sensing pad 73 generates a voltage between any or all of the electrodes 202 and the electrode 205 in response to force, pressure or vibration applied to a portion or the whole of the pad.

The spacing between the multiple electrodes 202 provided on one surface of the film 201 can be set to be less than the two-point discrimination threshold of the human touch object 101.

A predetermined voltage can be applied to the dielectric member 203 to precharge it.

Holes formed in the dielectric member 203 may extend from the first surface to the second surface.

Any one of the multiple electrodes 202 and electrode 205 can be disposed with film 201 and film 204 sandwiched between them, sandwiching the portion of dielectric member 203 in which the hole is formed.

The cross-sectional shape of the hole formed in the dielectric member 203 on the first surface can be made similar to the shape of the surface of the film-like electrode 202.

The electrode 202 can be disposed across the film 201 on a cross section of the hole formed in the dielectric member 203, the cross section being on the first surface.

Any one of the multiple electrodes 202 and electrode 205 can be disposed with film 201 and film 204 sandwiched therebetween, sandwiching a portion of dielectric member 311 other than the portion in which the hole is formed.

Springs 411-1 and 411-2 that sandwich and press the ends of film 201, film 204 and dielectric member 203 may further be provided.

A plurality of electrodes 361 may be provided, and each of the plurality of electrodes 361 may be provided at a position facing each of the plurality of electrodes 202.

When detecting the shape or pattern of the surface of the touch object 101 or the force of contact with the touch object 101, an air actuator 72 can be further provided to displace the film 201, the electrode 202, the film 204, the electrode 205 and the dielectric member 203 and press them against the touch object 101.

The air actuator 72 can displace the film 201, the electrode 202, the film 204, the electrode 205 and the dielectric member 203 and press them against the contact target 101 by gas or liquid pressure.

The film 20, the electrode 202, the film 204, the electrode 205 and the dielectric member 203 can be displaced and pressed against the contact object 101 by the cam 122 as a pressing means.

By pulling the wire 152 via the pulley 153 as a pressing means, the film 201, the electrode 202, the film 204, the electrode 205 and the dielectric member 203 can be displaced and pressed against the contact object 101.

Furthermore, the present invention is not limited to the above-described embodiment, and various modifications are possible without departing from the spirit and scope of the present invention.

### DESCRIPTION OF CODES

11 tactile sensing system, 21 tactile sensing pad group, 22 robot system, 41 tactile/pressure drive information calculation system, 42 virtual reality computer system/remote robot manipulation system, 43 image processing system, 71 and 71-1 to 71-4 tactile sensing unit, 72 and 72-1 to 72-4 air actuator, 73 and 73-1 to 73-4 tactile sensing pad, 101 contact object, 121 and 121-1 to 121-4 tactile sensing unit, 122 and 122-1 to 122-4 cam, 123 and 123-1 to 123-4 motor, 151 and 151-1 to 151-4 tactile sensing unit, 152 and 152-1 to 152-4 wire, 153, 153-1 to 153-4, 154 and 154-1 to 154-4 pulleys, 155 and 155-1 to 155-4 motors, 201 film, 202, 202-1 to 202-12 electrodes, 203 dielectric member, 204 film, 205 electrodes, 221, 221-1 to 221-12 holes, 251 tactile sensing pad 261 Dielectric member, 271, 271-1 to 271-9 Holes, 301 Tactile sensing pad, 311 Dielectric member, 321, 321-1 to 321-4 Holes, 351 Tactile sensing pad, 361, 361-1 to 361-12 Electrode, 401 Tactile sensing pad, 411-1 and 411-2 Spring, 501 Finger, 511 Fixing band

1. A sensor comprising:
a first film that generates voltage when force, pressure, or vibration is applied;
multiple first electrodes arranged on one side of the first film, spaced at predetermined intervals;
a second film that generates voltage when force, pressure, or vibration is applied;
a second electrode arranged on one side of the second film;
a dielectric member with holes, formed from rubber with dielectric properties, where the opposite side of the first film is attached to one surface of the dielectric member, and the opposite side of the second film is attached to the opposite surface;
wherein a storage material aiding in charge accumulation is placed in the holes formed in the dielectric member, and a voltage corresponding to the applied force, pressure, or vibration is generated between any or all of the first electrodes and the second electrode.

2. The sensor set forth in claim 1, wherein the spacing between the multiple first electrodes provided on one surface of the first film is less than the two-point discrimination threshold of human skin.

3. The sensor set forth in claim 1, wherein a predetermined voltage is applied to the dielectric member, and the dielectric member is precharged with an electric charge.

4. The sensor set forth in claim 1, wherein a hole formed in the dielectric member extends from the first surface to the second surface.

5. The sensor set forth in claim 1, wherein any one of the multiple first electrodes and the second electrode are arranged between the first film and the second film, sandwiching a portion of the dielectric member in which a hole is formed.

6. The sensor set forth in claim 5, wherein the cross-sectional shape of the hole formed in the dielectric member on the first surface is similar to the shape of the surface of the film-like first electrode.

7. The sensor set forth in claim 6, wherein the first electrode is disposed on a cross section of a hole formed in the dielectric member, with the first film in between, on the first surface.

8. The sensor set forth in claim 1, wherein any one of the multiple first electrodes and the second electrode are arranged between the first film and the second film to sandwich a portion of the dielectric member that is outside the portion in which a hole is formed.

9. The sensor set forth in claim 1, further including a pressing means for pinching and pressing the ends of the first film, the second film and the dielectric member.

10. The sensor set forth in claim 1, including a plurality of second electrodes, each of the second electrodes being provided at a position opposite to a corresponding one of the first electrodes.

11. The sensor set forth in claim 1, further including a pressing means for displacing the first film, the first electrode, the second film, the second electrode and the dielectric member and pressing them against the object when detecting the shape or pattern of the surface of the object or the force of contact with the object.

12. The sensor set forth in claim 11, wherein the pressing means uses gas or liquid pressure to displace and press the first film, the first electrode, the second film, the second electrode and the dielectric member against the target.

13. The sensor set forth in claim 11, wherein the pressing means uses a cam to displace the first film, the first electrode, the second film, the second electrode and the dielectric member and press them against the object.

14. The sensor set forth in claim 11, wherein the pressing means displaces and presses the first film, the first electrode, the second film, the second electrode and the dielectric member against the object by pulling a wire through a pulley.
